(19) United States
(12) Patent Application Publication
(10) Pub. No.: US 2018/0060093 A1
(43) Pub. Date: Mar. 1, 2018

(54) Platform Support For User Education Elements

(71) Applicant: Microsoft Technology Licensing, LLC, Redmond, WA (US)

(72) Inventor: Casey D. Irvine, Bellevue, WA (US)

(73) Assignee: Microsoft Technology Licensing, LLC, Redmond, WA (US)

(21) Appl. No.: 15/246,985

(22) Filed: Aug. 25, 2016

(51) Int. Cl. G06F 9/44; G06F 3/0484

(52) U.S. Cl. CPC G06F 9/4446; G06F 3/0484; G06F 8/20

(57) ABSTRACT

A computing device platform monitors the operation of an application that runs on the computing device platform. The computing device platform includes a user education element presentation system that can access stored presentation criteria associated with a stored user education element for the application. The user education element presentation system determines, based on the monitoring, when the presentation criteria has been satisfied, and presents the associated user education element in response to the presentation criteria for the user education element being satisfied.

### BACKGROUND

Many applications include features that provide user education, such as release notes, pop-up help boxes, and so forth. These user education elements help users understand the capabilities of the application and how to use those capabilities. Providing these user education elements, however, remains burdensome for the developer, adding complexity to the application and time to the application development.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more embodiments, operation of an application that runs on a computing device platform is monitored by the computing device platform. Stored presentation criteria associated with a stored user education element for the application is accessed, and a determination is made as to whether the presentation criteria has been satisfied. Responsive to determining that the presentation criteria has been satisfied, the user education element is displayed or otherwise presented.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example application development system implementing platform support for user education elements in accordance with one or more embodiments.

FIG. 2 is a block diagram illustrating an example computing device platform implementing platform support for user education elements in accordance with one or more embodiments.

FIG. 3 illustrates an example of user education elements implemented as coach marks in accordance with one or more elements.

FIG. 4 illustrates an example of user education elements implemented as a first-run page in accordance with one or more elements.

FIG. 5 is a flowchart illustrating an example process for implementing platform support for user education elements in accordance with one or more embodiments.

FIG. 6 illustrates an examples system generally that includes an example computing device that is representative of one or more systems and/or device that may implement the various techniques described herein.

### DETAILED DESCRIPTION

Platform support for user education elements is discussed herein. An application developer uses an application development system to develop an application for a particular platform (e.g., a particular operating system). The application developer specifies user education elements and presentation criteria that are to be satisfied in order for the user education elements to be displayed or otherwise presented. User education elements are instructions that help a user understand and operate the application, such as first run experience (FRE) pages or screens, coach marks, and so forth. The presentation criteria define one or more operating conditions and/or events, with respect to operation of the application, that are to be satisfied in order to present the user education element associated with the one or more presentation criteria.

When the application is subsequently run on the platform, the platform monitors operation of the application. The platform compares the operation of the application to the presentation criteria for the application (as specified by the application developer), and determines whether the presentation criteria for one or more of the user education elements is satisfied. In response to determining that the presentation criteria for a user education element is satisfied, the platform displays or otherwise presents the user education element.

The techniques discussed herein allow an application to specify to a platform on which the application is run user education elements to present and the presentation criteria to be satisfied in order for the user education elements to be presented. The application developer can simply specify in the application the user education elements, the presentation criteria, and optionally the operation(s) the platform is to monitor to determine that the presentation criteria have been met. The application developer can then rely on the platform to perform the monitoring of operation of the application to determine when the presentation criteria are satisfied. This reduces application development time because the application developer need not write custom code to monitor the operation of the application. This also improves application performance because debugged monitoring code can be implemented by the platform once and used by multiple applications, providing a correct and consistent monitoring experience across multiple applications.

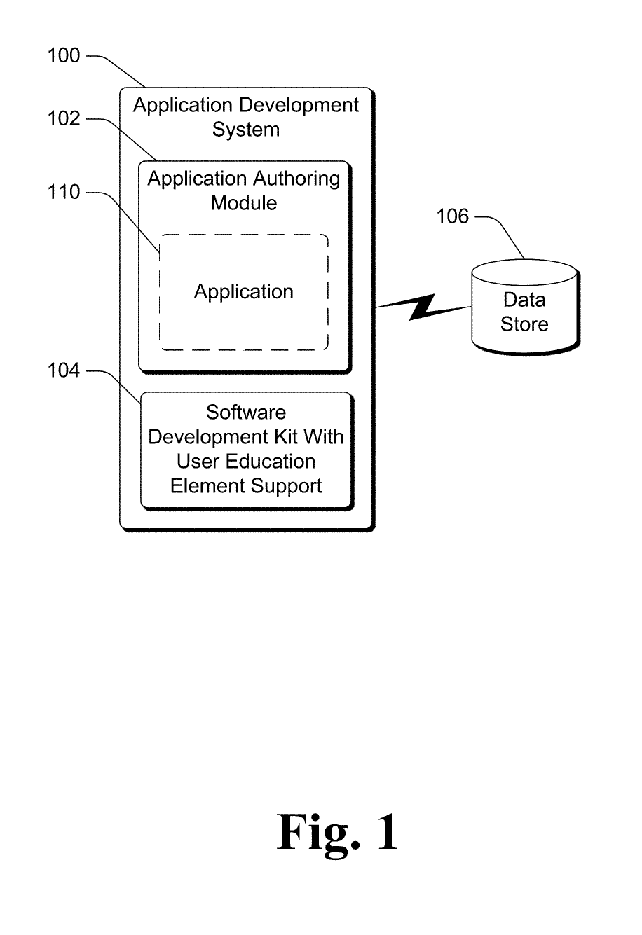

FIG. 1 is a block diagram illustrating an example application development system 100 implementing platform support for user education elements in accordance with one or more embodiments. The application development system 100 can be implemented using one or more of a variety of different types of devices. For example, the application development system 100 can be implemented using any of a variety of computing devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the application development system 100 may be implemented using devices ranging from a full resource device with substantial memory and processor resources (e.g., personal computers, game consoles) to a low-resource device with limited memory and/or processing resources (e.g., traditional set-top boxes, hand-held game consoles).

The application development system 100 includes an application authoring module 102 and a software development kit with user education element support 104. Although particular functionality is discussed herein with reference to the application authoring module 102 and the software development kit with user education element support 104, it should be noted that the functionality of the application authoring module 102 and the software development kit with user education element support 104 can be separated into multiple modules, and/or at least some functionality of the application authoring module 102 and the software development kit with user education element support 104 can be combined into a single module.

The application development system 100 can access a data store 106. The data store 106 can be implemented in a variety of different manners, such as using a magnetic disk drive, solid state memory, and so forth. The data store 106 can be included as part of a same computing device as implements the application development system 100, or alternatively can be implemented separately from the computing device implementing the application development system 100. If implemented separately, the computing device implementing the application development system 100 and the data store 106 can be coupled to one another via a wired or wireless connection, such as a USB (universal serial bus) connection, a wireless USB connection, an infrared connection, a Bluetooth connection, a DisplayPort connection, a PCI (a peripheral component interconnect) Express connection, and so forth. The computing device implementing the application development system 100 can alternatively or additionally be connected to the digital signature 106 via a data network, such as the Internet, a local area network (LAN), a public telephone network, an intranet, other public and/or proprietary networks, combinations thereof, and so forth.

The application authoring module 102 can be used to develop applications for a variety of computing device platforms. A computing device platform (also referred to as simply a platform) refers to an operating system for a computing device or an operating system version for a computing device. In some situations different versions of an operating system are used for different devices (e.g., one version for desktop and laptop devices, another version for mobile devices such as smartphones, and another version for wearable devices). For example, the platform can be the Microsoft Windows® family of operating systems, the Android family of operating systems, the iOS operating system, and so forth. An example application 110 being developed by a developer is shown with dashed lines inside the application authoring module 102. It should be noted that the code for the example application 110 can be stored in any location accessible by the application authoring module 102 (e.g., data store 106).

The application authoring module 102 receives user inputs from a user of the application development system 100. The user inputs describe both user education elements for presentation by the application (e.g., the example application 110) and presentation criteria that are to be satisfied to cause the user education element to be presented. In one or more embodiments, the user inputs also describe the operation(s) the platform monitors to determine that the presentation criteria have been met.

User education elements are instructions that help a user understand and operate the application. Examples of user education elements include a first run experience, coach marks, and so forth. A first run experience (FRE) is a page or screen element that is presented the first time an application runs (e.g., after installation or after an application update). The FRE may be a single page or series of pages that provide instructions, links to tutorials, customization options, and so forth. Coach marks are instructions or tips related to specific features of the application. For example, a coach mark could be a pop-up box that tells a user how to pin an item to a list of favorites, how to return to a home screen, and so forth. Another example of a coach mark is a control that allows a user to view all of the shortcuts (e.g., keyboard, voice, or touch) that are available from the user's current screen in the application.

The application authoring module 102 allows an application developer to select and configure user education elements (e.g., FRE pages and coach marks), along with the presentation criteria that is to be satisfied to cause the user education element to be presented in the application. The application developer uses the authoring module 102 to select the content for the user education element—in other words, what is to be presented when the presentation criteria is satisfied. Additionally, the application authoring module 102 can enable the application developer to let users stop user education elements from being displayed (e.g., allow users to opt out from the presentation of user education elements). For example, the application developer may include, in the first presentation of a particular user education element, an option for the user to stop presenting the current user education element, stop presenting all user education elements, or both (e.g., the user education element includes, or is accompanied by, a dialog box with options such as “don't show this user education element again” and/or “stop showing all user education elements”, and so forth).

The content of the user education element can be presented in various formats (e.g., text, audio, video, and so forth) that can also be selected using the application authoring module 102. For example, an application developer may use the application authoring module 102 to select a coach mark that is configured as text window that displays the text “Tap the ♡ button to save this page to your favorites list.” The application authoring module 102 may also provide an option to select a sound to play when the coach mark is displayed. In another example, the application developer may use the application authoring module 102 to select a coach mark that is configured as an audio file that the application plays that recites “Say ‘save to favorites’ to save this page to your favorites list”.

A format for the coach mark can also be specified. In the case of the text window coach mark described above, for example, the text window may have a frame. The application authoring module 102 may allow the developer to select a frame shape (square, oval, and so forth), a frame border color, a frame background color, a text font, a text color, a user interface for interacting with the user education element (e.g., options to close the window, show the window again later, and so forth). Other examples of formatting options can include a line type for the frame, sounds, animations, and so forth. In the example of the coach mark as an audio file, the formatting options can include selecting the language, the play speed, and so forth. Additionally or alternatively, the application authoring module 102 provides an option to select a default format or to create a custom format as described above.

User education elements are presented to users in response to satisfaction of one or more presentation criteria. The presentation criteria define one or more operating conditions and/or events, with respect to operation of the application, that are to be satisfied to present the user education element associated with the one or more presentation criteria. The presentation criteria can also be selected using the application authoring module 102. Examples of presentation criteria include an initial activation of a function of the application, a subsequent activation of the function of the application after a predetermined time period during which the function is not activated, a failure to activate a feature of the application for a predetermined time period, an initial operation of the application after installation, an initial operation of the application after an update to the application, selection of a help button, a subsequent activation of the function (e.g., the third or fifth activation) regardless of the time since any previous activation, and so forth.

The presentation criteria can also be selected so that the coach mark is presented if the user appears unware of the feature. For example, if a user navigates to a page a threshold number of times (e.g., five times) without accessing the feature, a coach mark can be displayed to alert the user that feature exists. In other cases, the presentation criteria is selected to help the user be more efficient, so that if a user performs a task a threshold number of times (e.g., three times) a coach mark may be presented that explains a more efficient way to perform the task, such by saving a page to a favorites list or displaying a voice, touch, or keyboard shortcut that performs the tasks with fewer steps or in less time.

To determine whether the presentation criteria has been satisfied, events and/or operations in the application are monitored to determine whether to present the user education element. The application developer may use the application authoring module 102 to specify the particular events to be monitored (e.g., how many times a user visits a particular page or screen). The application developer may specify predefined events available in the application authoring module 102 or use the application authoring module 102 to create custom events (e.g., combinations of predefined events, events that are not predefined events, and so forth). Additionally or alternatively, the application authoring module 102 may automatically specify which events to monitor based on the particular user education element. For example, the FRE is presented when the application is started and runs for the first time, either the first run after the application is installed or the first run after the application is updated. Thus, the application and/or the operating system running the application will be monitored when the application starts to determine whether it is the first run.

In one or more embodiments, the application developer may use the application authoring module 102 to specify the operation(s) the platform is to monitor to determine that the presentation criteria have been met. For example, the operation(s) of the application 110 that are to be monitored by the platform to determine when custom events occur. Additionally or alternatively, the operation(s) the platform is to monitor to determine that the presentation criteria have been met can be inherent in the presentation criteria. For example, if the presentation criteria is that the application runs for the first time after installation, then it is inherent in the presentation criteria that running of the application is an operation that is to be monitored by the platform.

The software development kit (SDK) with user education element support 104 provides various libraries and tools that are available to an application developer to assist in authoring the application 110. For example, the SDK 104 may include libraries of code (e.g., XAML, C#, and so forth) that can be included with or used by the application when it runs. By way of another example, the SDK 104 may include tools that facilitate development of the application 110 and specification of user education elements and/or presentation criteria. The SDK 104 can also include other tools (e.g., for testing, debugging, and so forth) to assist in authoring the application.

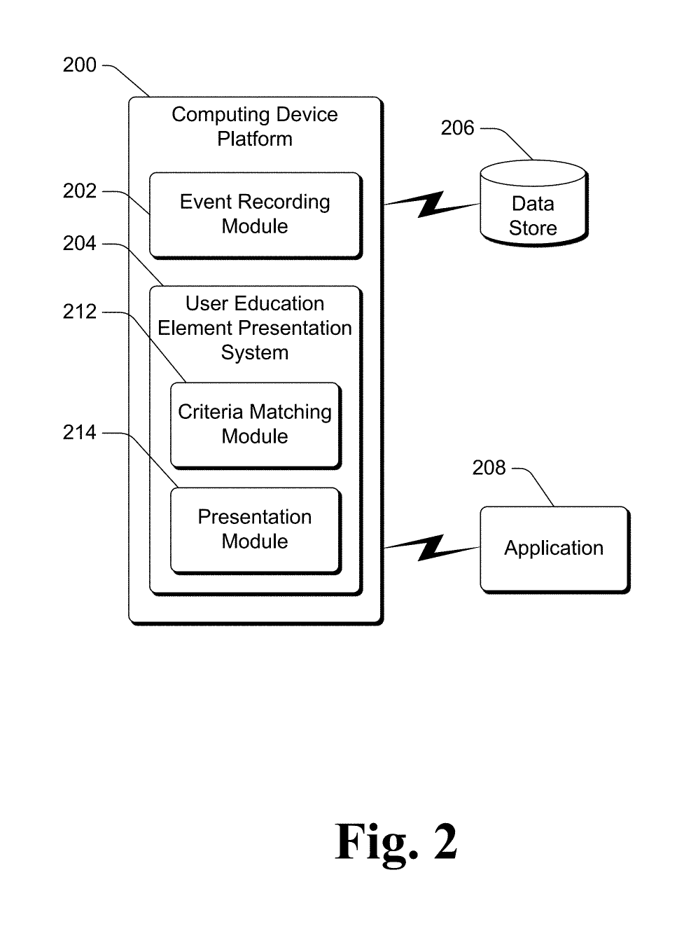

FIG. 2 is a block diagram illustrating an example computing device platform 200 implementing platform support for user education elements in accordance with one or more embodiments. The computing device platform 200 can be implemented using one or more of a variety of different types of devices, for example any of the types of computing devices used to implement the application development system 100 of FIG. 1. Thus, the computing device platform 200 may be implemented using devices ranging from a full resource device with substantial memory and processor resources (e.g., personal computers, game consoles) to a low-resource device with limited memory and/or processing resources (e.g., traditional set-top boxes, hand-held game consoles).

The computing device platform 200 includes an event recording module 202 and a user education element presentation system 204. Although particular functionality is discussed herein with reference to the event recording module 202 and the user education element presentation system 204, it should be noted that the functionality of the event recording module 202 and the user education element presentation system 204 can be separated into multiple modules, and/or at least some functionality of the event recording module 202 and the user education element presentation system 204 can be combined into a single module.

The computing device platform 200 can access a data store 206. The data store 206 can be implemented in a variety of different manners, such as using a magnetic disk drive, solid state memory, and so forth. The data store 206 can be included as part of a same computing device as implements the computing device platform 200, or alternatively can be implemented separately from the computing device implementing the computing device platform 200. If implemented separately, the computing device implementing the computing device platform 200 and the data store 206 can be coupled to one another via a wired or wireless connection, such as a USB connection, a wireless USB connection, an infrared connection, a Bluetooth connection, a DisplayPort connection, a PCI Express connection, and so forth. The computing device implementing the computing device platform 200 can alternatively or additionally be connected to the digital store 206 via a data network, such as the Internet, a LAN, a public telephone network, an intranet, other public and/or proprietary networks, combinations thereof, and so forth.

An application 208 also runs on the computing device platform 200. The application 208 is, for example, the application 110 of FIG. 1 after the developer has completed authoring the application 110.

The event recording module 202 and the user education element presentation system 204 are used to enable an application (e.g., application 208) to implement user education elements. As described above, user education elements are instructions that help a user understand and operate the application, such as a first run experience, coach marks, and so forth. The user education elements are presented to users in response to satisfaction of a presentation criteria. The presentation criteria defines the operating conditions or events, with respect to operation of the application, that are to be satisfied to present the user education element associated with the presentation criteria.

The event recording module 202 identifies selected operational events of the application 208 and stores data describing the operational events in a data store (e.g., data store 206). For example, event recording module 202 can record the number of times a page of the application 208 is visited within a specified time period, the number of times a particular feature is accessed, a time and/or date when the application 208 was installed or most recently updated, and so forth. In either case, the event recording module 202 stores data that describes the operation event or run status. The event recording module 202 can identify operational events of the application 208 in one or more of a variety of different manners, such as by monitoring requests made or operating system functionality invoked by the application 208, by receiving notifications from the application 208 of events (e.g., a particular page of the application that is accessed), and so forth.

In one or more embodiments, the event recording module 202 records a particular set of events regardless of the presentation criteria for the application 208. For example, the event recording module 202 can be pre-configured with a particular set of events to record. Alternatively, the event recording module 202 can analyze the presentation criteria for the application 208 (and optionally any other applications with presentation criteria for user education elements) and automatically determine which events to record. For example, if the presentation criteria for the application 208 includes presenting a particular first run experience for the application 208, then the event recording module 202 automatically determines to record an event indicating when the application 208 is initially run. However, if the presentation criteria for the application 208 does not include presenting a particular first run experience for the application 208, then the event recording module 202 can automatically determine that it need not record an event indicating when the application 208 is initially run.

The user education element presentation system 204 includes a criteria matching module 212 and a presentation module 214. The criteria matching module 212 monitors operation of the application 208 to determine when the operational events satisfy a presentation criteria. The presentation criteria is used to control presentation of a user education element. The presentation criteria may be a particular operational event performed by the application 208 or a series of operational events. The presentation criteria may be stored in a memory integrated with the criteria matching module 212 or in another location (e.g., data store 206).

The criteria matching module 212 monitors operation of the application 208 and compares the data stored by event recording module 202 with the conditions defined by the presentation criteria to determine whether the presentation criteria has been satisfied. Continuing the above example, the criteria matching module 212 monitors the operation of the application 208 and the data stored by the event recording module 202. When the data describing the number of times a particular page of the application 208 is visited within a specified time period matches the number of visits defined by the presentation criteria, the criteria matching module 212 determines that the presentation criteria has been satisfied.

The presentation module 214 presents a stored user education element, via the application 208, when an associated presentation criteria has been satisfied. For example, the presentation module 214 provides the stored user education element (or an indication/identifier of the stored user education element) to the application 208. Returning to the above example, once the criteria matching module 212 determines that the presentation criteria has been satisfied, the presentation module causes the application 208 to present a coach mark that is a text window containing the text “Tap the ♡ button to save this page to your favorites list.” In another example, the presentation module 214 causes the application 208 to present a first run experience page that is a page that provides an overview of the functionality of the application 208 and links to additional pages (e.g., tutorials, customization options, and so forth).

In one or more embodiments, the event recording module 202, the criteria matching module 212, and the presentation module 214 operate across multiple user devices. For example, a user may log into the application 208 via a mobile device while traveling to work and then log in again via a desktop device at the office. In this situation, the event recording module 202 records the events across both devices. The criteria matching module 212 also monitors the application 208 on both devices and may determine that presentation criteria have been met based on cumulative monitoring of the mobile device and the desktop device, along with the events recorded by the event recording module 202. Consider an example presentation criteria of three visits to a particular application page within an hour. The user may visit the page twice while traveling to work (via the mobile device) and a third time upon arriving at work (via the desktop device). The criteria matching module 212 determines that the presentation criteria has been satisfied by the three cumulative events, and the presentation module 214 presents the associated user education element on the desktop device.

Additionally or alternatively, the computing device platform (e.g., using the event recording module 202) determines the user education elements that have previously been presented by the application. In response to such a determination, the presentation module 214 stops presenting the previously presented user education elements after subsequent satisfaction of the presentation criteria.

The criteria and the user education elements for the application 208 can be provided to the user education element presentation system 204 in a variety of different manners. In one or more embodiments, the criteria and user education elements for the application 208 are provided to the user education element presentation system 204 when the application 208 begins running, such as by the application 208 invoking an application programming interface (API) of the user education element presentation system 204. Additionally or alternatively, at least part of the criteria and/or user education elements for the application 208 can be provided to the user education element presentation system 204 at other times, such as during installation or updating of the application 208 on a computing device. The criteria and/or user education elements for the application 208 can be stored in the data store 206, and subsequently accessed by the user education element presentation system 204 when the application 208 runs.

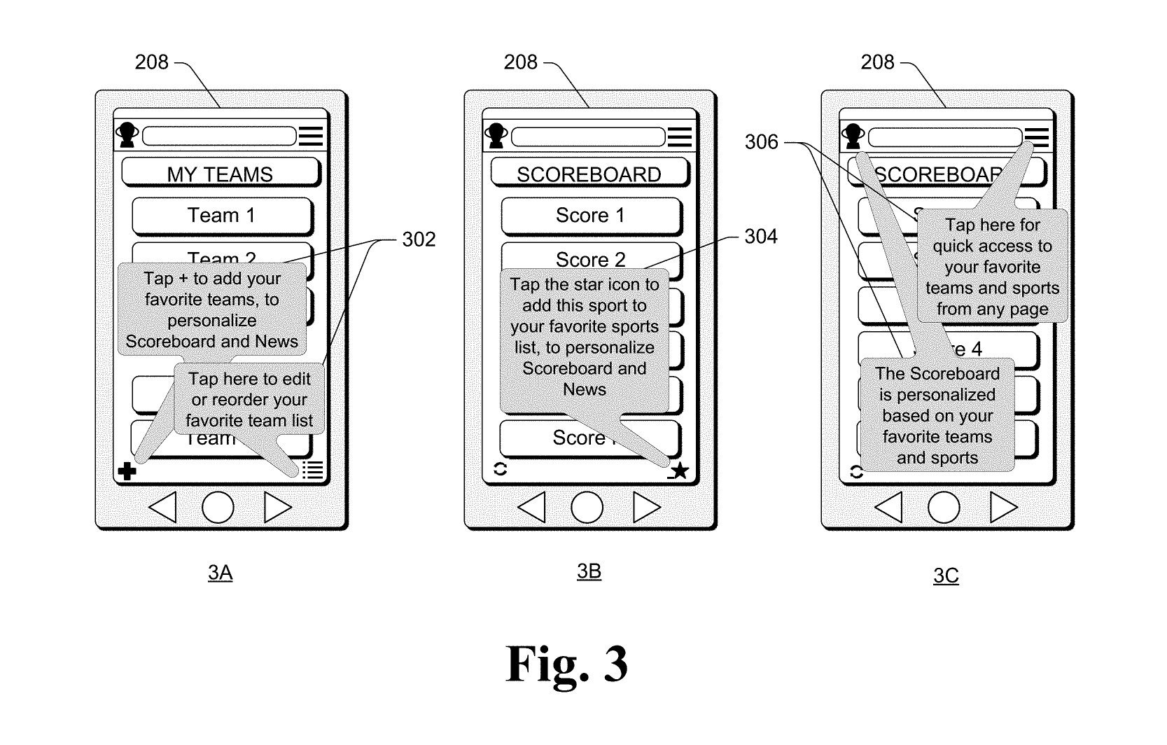

FIG. 3 illustrates examples of user education elements in additional detail in accordance with one or more embodiments. In example 3A of FIG. 3, the presentation module 214 presents user education elements 302. The user education elements 302 are coach marks that describe how to reorganize or add elements to a page of the application 208 (e.g., in response to satisfaction of a presentation criteria related to the number of times the page has been visited within a specified time period). Example 3B of FIG. 3 illustrates user education element 304, presented by the presentation module 214. The user education element 304 is another coach mark that describes how to add an element of a page of the application 208 to a favorites list (e.g., in response to satisfaction of a presentation criteria related to the number of times the element has been accessed within a specified time period). In example 3C of FIG. 3, the presentation module 214 presents user education elements 306. The user education elements 306 are coach marks that describe how to access elements of application 208 that have been saved to a favorites lists from any page of the application 208 via a shortcut key (e.g., in response to satisfaction of a presentation criteria related to the number of times the favorites list has been accessed via a less efficient means).

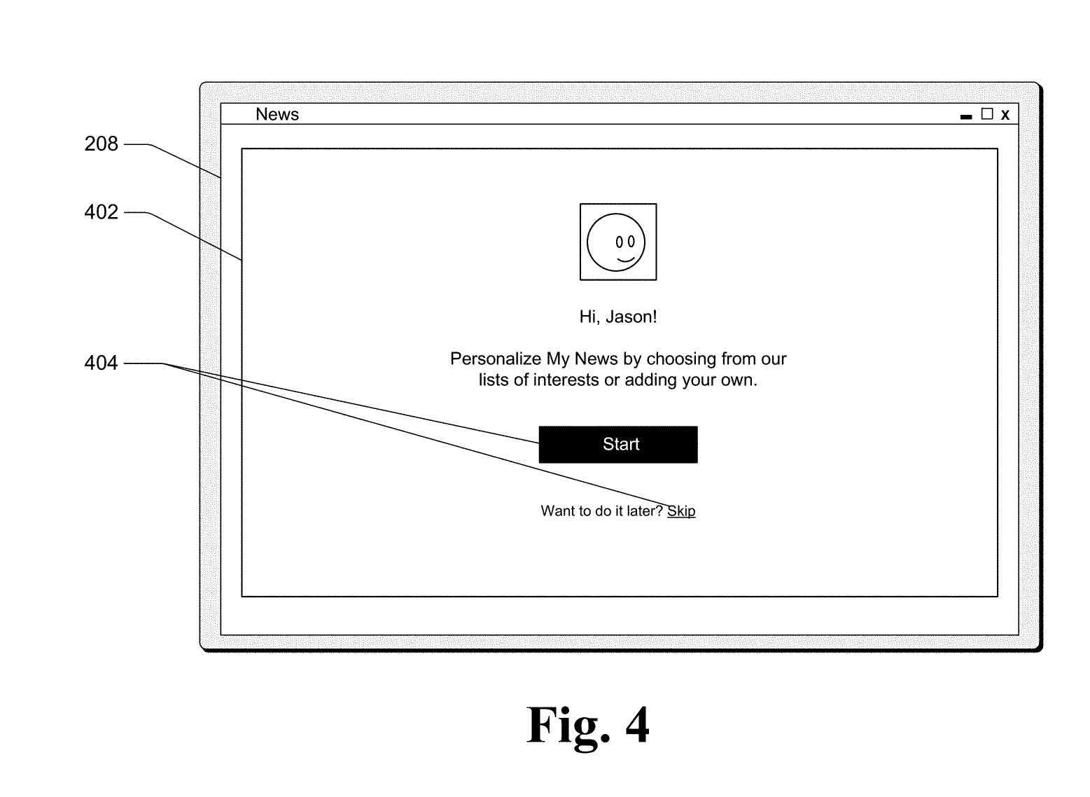

FIG. 4 illustrates another example 400 of user education elements in additional detail in accordance with one or more embodiments. In the example of FIG. 4, the presentation module 214 presents user education element 402. The user education element 402 is a first run experience page (i.e., the user education element 402 is presented in response to satisfaction of a presentation criteria requiring that the application 208 is being run for the first time after installation or after an update). The user education element 402 provides an overview of the functionality of the application 208 and links to additional pages (e.g., “Start” and “Skip”).

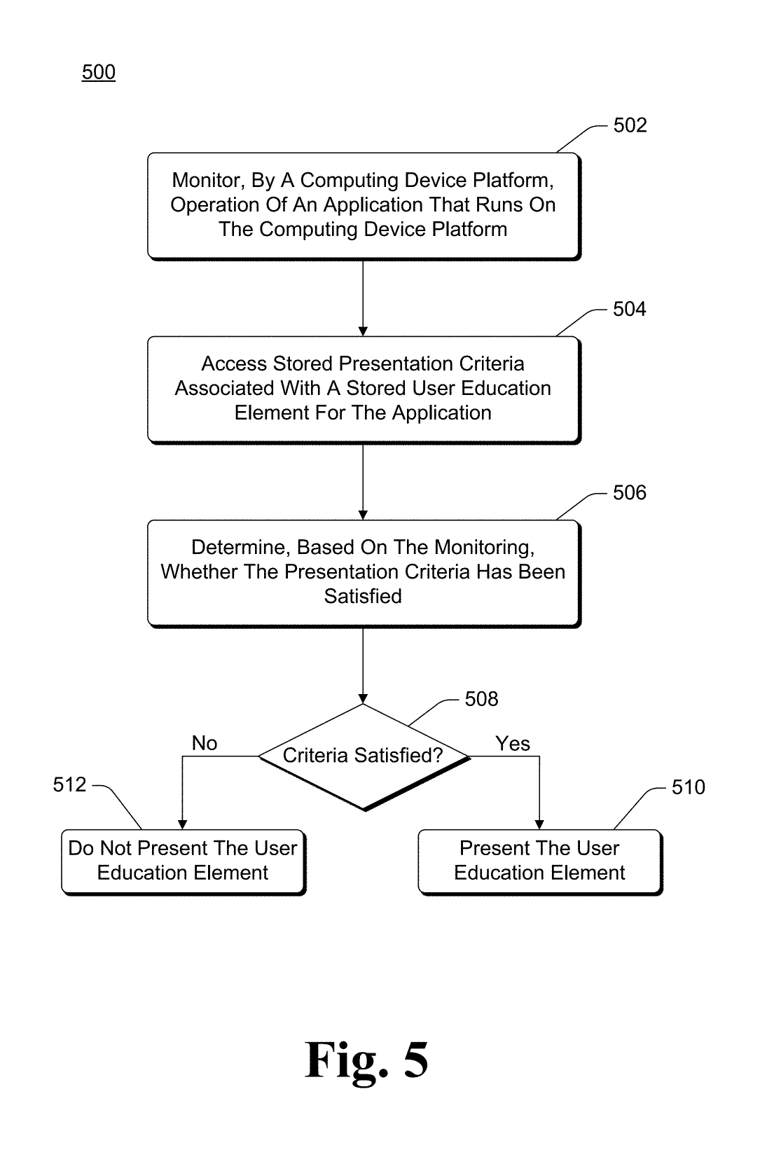

FIG. 5 is a flowchart illustrating an example process 500 for implementing platform support for user education elements in accordance with one or more embodiments. The process 500 is carried out by a computing device platform, such as the computing device platform 200 of FIG. 2, and can be implemented in software, firmware, hardware, or combinations thereof. The process 500 is shown as a set of acts and is not limited to the order shown for performing the operations of the various acts. The process 500 is an example process for implementing platform support for user education elements; additional discussions of implementing platform support for user education elements are included herein with reference to different figures.

In process 500, operation of an application that runs on the computing device platform is monitored by the computing device platform (act 502). The monitoring refers to monitoring events that occur during running of the application, such as activation of a function of the application, a time that a function of the application is activated, selection of a help button, and so forth.

A stored presentation criteria, associated with a stored user education element for the application is then accessed (act 504). As discussed above, the presentation criteria is used to control presentation of the user education element. The presentation criteria is specific to the application, and different applications can have different presentation criteria.

Based on the monitoring, it is determined whether the presentation criteria has been satisfied (act 506). As discussed above, the determination can be made by a comparison of the requirements defined by the presentation criteria with the stored data that describes operational events of the application.

The process 500 proceeds based on whether the presentation criteria is determined to be satisfied (act 508). If the presentation criteria is determined to be satisfied, then the user education element associated with the presentation criteria is presented via the application (act 510). If, however, the presentation criteria is determined not to be satisfied, then the user education element associated with the presentation criteria is not presented (act 512). As discussed above, the user education element may be a coach mark that provides instructions for using a function of the application (e.g., a text window, video or audio presentation, and so forth) or a first run experience page (e.g., a page that provides an overview of the functionality of the application and links to additional pages such as tutorials, customization options, and so forth).

Additionally or alternatively, the computing device platform determines the user education elements that have previously been presented by the application. In response to such a determination, the computing device platform stops presenting the previously presented user education elements after subsequent satisfaction of the presentation criteria. The determination of previously presented user education elements and the cessation of presenting the previously presented user education elements can be performed and/or controlled by a module or system such as the user education element presentation system 204 of FIG. 2. Thus, the presentation criteria can be used by the computing device platform to determine when to display or otherwise present a user education element, as well as when to cease displaying or otherwise presenting a user education element.

In one or more embodiments, the presentation criteria is selection of a help button. When the help button is selected, the stored user education elements that are related to the application features currently accessible are determined. All of the stored user education elements related to the application features currently accessible from the application when the help button is selected are then presented by the application (e.g., by presentation module 214).

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

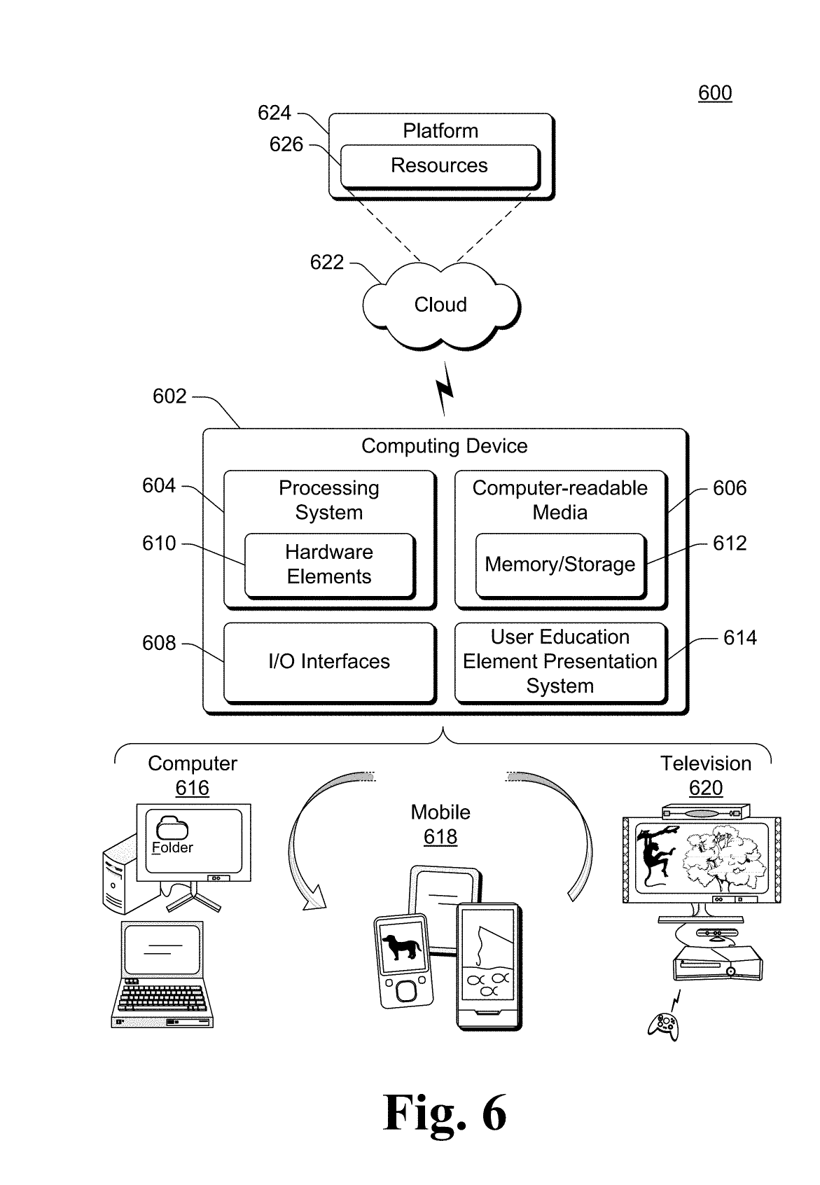

FIG. 6 illustrates an example system generally at 600 that includes an example computing device 602 that is representative of one or more systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O Interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Resistive RAM (ReRAM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

The one or more input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

The computing device 602 also includes a user education element presentation system 614. The user education element presentation system 614 provides various user education functionality, including monitoring the operation of an application and controlling presentation of various user education elements, as discussed above. The user education element presentation system 614 can be, for example, a user education element presentation system 204 of FIG. 2. The computing device 602 also includes an event recording module (e.g., an event recording module 202 of FIG. 2), which can be included as part of the user education element presentation system 614 or alternatively separate from the user education element presentation system 614.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 602 may assume a variety of different configurations, such as for computer 616, mobile 618, and television 620 uses. Each of these configurations includes devices that may have generally different constructs and capabilities, and thus the computing device 602 may be configured according to one or more of the different device classes. For instance, the computing device 602 may be implemented as the computer 616 class of a device that includes a personal computer, desktop computer, a multi-screen computer, laptop computer, netbook, and so on.

The computing device 602 may also be implemented as the mobile 618 class of device that includes mobile devices, such as a mobile phone, portable music player, portable gaming device, a tablet computer, a multi-screen computer, and so on. The computing device 602 may also be implemented as the television 620 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This functionality may also be implemented all or in part through use of a distributed system, such as over a “cloud” 622 via a platform 624 as described below.

The cloud 622 includes and/or is representative of a platform 624 for resources 626. The platform 624 abstracts underlying functionality of hardware (e.g., servers) and software resources of the cloud 622. The resources 626 may include applications and/or data that can be utilized while computer processing is executed on servers that are remote from the computing device 602. Resources 626 can also include services provided over the Internet and/or through a subscriber network, such as a cellular or Wi-Fi network.

The platform 624 may abstract resources and functions to connect the computing device 602 with other computing devices. The platform 624 may also serve to abstract scaling of resources to provide a corresponding level of scale to encountered demand for the resources 626 that are implemented via the platform 624. Accordingly, in an interconnected device embodiment, implementation of functionality described herein may be distributed throughout the system 600. For example, the functionality may be implemented in part on the computing device 602 as well as via the platform 624 that abstracts the functionality of the cloud 622.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A computing device comprising: a processor; and a computer-readable storage medium having stored thereon multiple instructions that implement a platform of the computing device and that, responsive to execution by the processor, cause the processor to: monitor operation of an application running on a platform of the computing device; access a stored presentation criteria related to a stored user education element for the application; based on the monitoring, determine that the stored presentation criteria has been satisfied; and responsive to determining that the stored presentation criteria has been satisfied, present the stored user education element.

Alternatively or in addition to any of the above described computing devices, any one or combination of: wherein the stored presentation criteria is one or more of an initial activation of a function of the application, a subsequent activation of the function of the application after a predetermined time period during which the function is not activated, a failure to activate a feature of the application for a predetermined time period, an initial operation of the application after installation, and an initial operation of the application after an update to the application; wherein the stored user education element is a coach mark; wherein the coach mark is a dialog box containing instructions related to operation of a function of the application for which the coach mark is displayed; wherein the stored user education element is a first run page; wherein the first run page is a page of the application displaying an overview of the functionality of the application and links to additional pages; wherein the stored user education element includes a format, the format comprising one of more of a frame shape, a frame border color, a frame background color, a text font, a text color, and a user interface for interacting with the user education element; wherein the stored presentation criteria is user selection of a help button; wherein the multiple instructions further cause the processor to determine multiple stored user education elements that are related to application features accessible from the application when the help button is selected, and present all of the multiple stored user education elements related to the application features accessible from the application when the help button is selected; wherein the multiple instructions further cause the processor to determine one or more user education elements that have been presented by the application, and responsive to determining that the one or more user education elements has previously been presented, not presenting the one or more user education elements after subsequent satisfaction of the presentation criteria.

A method comprising: monitoring, by a computing device platform, operation of an application that runs on the computing device platform; accessing a stored presentation criteria associated with a stored user education element for the application; determining, based on the monitoring, that the stored presentation criteria has been satisfied; and responsive to determining that the stored presentation criteria has been satisfied, presenting the stored user education element.

Alternatively or in addition to any of the above described methods, any one or combination of: wherein the stored user education element is a coach mark; wherein the coach mark is a dialog box containing instructions related to operation of a function of the application for which the coach mark is displayed; wherein the stored user education element is a first run page; wherein the first run page is a page of the application containing an overview of the functionality of the application and links to additional pages.

A system implemented in a computing device, the system comprising: an event recording module implemented at least partially in hardware to identify selected operational events of an application and store data describing the operational events in a data store; and a user education element presentation system, further comprising: a criteria matching module implemented at least partially in hardware to monitor operation of the application to determine that the operational events satisfy a presentation criteria; and a presentation module implemented at least partially in hardware to, responsive to determining that the presentation criteria has been satisfied, present a stored user education element via the application.

Alternatively or in addition to any of the above described systems, any one or combination of: wherein the stored user education element is a coach mark; wherein the coach mark is a dialog box containing instructions related to operation of a function of the application for which the coach mark is displayed; wherein the stored user education element is a first run page; wherein the first run page is a page of the application containing an overview of the functionality of the application and links to additional pages.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device comprising:
a processor; and
a computer-readable storage medium having stored thereon multiple instructions that implement a platform of the computing device and that, responsive to execution by the processor, cause the processor to:
monitor operation of an application running on a platform of the computing device;
access a stored presentation criteria related to a stored user education element for the application;
based on the monitoring, determine that the stored presentation criteria has been satisfied; and
responsive to determining that the stored presentation criteria has been satisfied, present the stored user education element.

2. The computing device of claim 1, wherein the stored presentation criteria is one or more of:
an initial activation of a function of the application;
a subsequent activation of the function of the application after a predetermined time period during which the function is not activated;
a failure to activate a feature of the application for a predetermined time period;
an initial operation of the application after installation; and
an initial operation of the application after an update to the application.

3. The computing device of claim 1, wherein the stored user education element is a coach mark.

4. The computing device of claim 3, wherein the coach mark is a dialog box containing instructions related to operation of a function of the application for which the coach mark is displayed.

5. The computing device of claim 1, wherein the stored user education element is a first run page.

6. The computing device of claim 5, wherein the first run page is a page of the application displaying an overview of the functionality of the application and links to additional pages.

7. The computing device of claim 1, wherein the stored user education element includes a format, the format comprising one of more of:
a frame shape;
a frame border color;
a frame background color;
a text font;
a text color; and
a user interface for interacting with the user education element.

8. The computing device of claim 1, wherein the stored presentation criteria is user selection of a help button.

9. The computing device of claim 8, wherein the multiple instructions further cause the processor to:
determine multiple stored user education elements that are related to application features accessible from the application when the help button is selected; and
present all of the multiple stored user education elements related to the application features accessible from the application when the help button is selected.

10. The computing device of claim 1, wherein the multiple instructions further cause the processor to:
determine one or more user education elements that have been presented by the application; and
responsive to determining that the one or more user education elements has previously been presented, not presenting the one or more user education elements after subsequent satisfaction of the presentation criteria.

11. A method comprising:
monitoring, by a computing device platform, operation of an application that runs on the computing device platform;
accessing a stored presentation criteria associated with a stored user education element for the application;
determining, based on the monitoring, that the stored presentation criteria has been satisfied; and
responsive to determining that the stored presentation criteria has been satisfied, presenting the stored user education element.

12. The method of claim 11, wherein the stored user education element is a coach mark.

13. The method of claim 12, wherein the coach mark is a dialog box containing instructions related to operation of a function of the application for which the coach mark is displayed.

14. The method of claim 11, wherein the stored user education element is a first run page.

15. The method of claim 14, wherein the first run page is a page of the application containing an overview of the functionality of the application and links to additional pages.

16. A system implemented in a computing device, the system comprising:
an event recording module implemented at least partially in hardware to identify selected operational events of an application and store data describing the operational events in a data store; and
a user education element presentation system, further comprising:
a criteria matching module implemented at least partially in hardware to monitor operation of the application to determine that the operational events satisfy a presentation criteria; and
a presentation module implemented at least partially in hardware to, responsive to determining that the presentation criteria has been satisfied, present a stored user education element via the application.

17. The system of claim 16, wherein the stored user education element is a coach mark.

18. The system of claim 17, wherein the coach mark is a dialog box containing instructions related to operation of a function of the application for which the coach mark is displayed.

19. The system of claim 16, wherein the stored user education element is a first run page.

20. The system of claim 19, wherein the first run page is a page of the application containing an overview of the functionality of the application and links to additional pages.
